(19) United States
(12) Patent Application Publication
(10) Pub. No.: US 2024/0320370 A1
(43) Pub. Date: Sep. 26, 2024

(54) ENHANCING USER PRIVACY USING NON-UNIQUE USER IDENTIFIERS

(71) Applicant: Google LLC, Mountain View, CA (US)

(72) Inventor: Scott David Schneider, Burbank, CA (US)

(21) Appl. No.: 18/188,968

(22) Filed: Mar. 23, 2023

(51) Int. Cl. G06F 21/62

(52) U.S. Cl. CPC G06F 21/6254

(57) ABSTRACT

Methods, systems, and apparatus, including computer programs encoded on a computer storage medium, for distributing digital contents to client devices are described. The system obtains privacy-preserving user data, including non-unique user IDs, for a set of users. The system processes the privacy-preserving user data to estimate one or more metrics for one or more digital components. The system adjusts, based on the estimated metrics, one or more distribution parameters, and distributes digital components to the client devices based on the distribution parameters.

### TECHNICAL FIELD

This specification is generally related to data processing, data privacy, and data security.

### BACKGROUND

Data security and user privacy are vital in systems and devices connected to public networks, such as the Internet. The enhancement of user privacy has led many developers to change the ways in which user data is handled. For example, some browsers are planning to deprecate the use of third-party cookies.

### SUMMARY

This specification describes methods, computer systems, and apparatus, including computer programs encoded on computer storage media, for generating and processing non-identifying user data to select and provide digital content to client devices in privacy-preserving manners.

In one innovative aspect, this specification describes a method for distributing digital components to a client device. The method can be implemented by a system including one or more computers.

The system obtains privacy-preserving user data for a set of users. The privacy-preserving user data includes, for each user in the set of users, a respective non-unique user ID comprising a bit string and data about digital components presented to users that have been assigned the non-unique user ID. Each bit string has a specific bit-string length that is less than a threshold length that allows a bit string to uniquely identify each user in the set of users.

The system processes the privacy-preserving user data to estimate one or more metrics for one or more digital components, and adjusts, based on the estimated one or more metrics, one or more distribution parameters for distributing digital components to client devices in response to digital component requests. The system can then distribute digital components to the client devices based on the distribution parameters.

In some implementations, the non-unique user ID for each user is generated by a random number generator of a client device of the user.

In some implementations, the non-unique user ID is generated by selecting bits from a respective hash bit string computed by hashing a unique user ID that uniquely identifies the respective user.

In some implementations, the system determines the bit-string length of the respective bit string to guarantee, with a predefined confidence level, that a same bit string is assigned to at least a predefined number of users in the set of plurality of users.

In some implementations, the metrics include a reach metric that characterizes a total number of unique users in the set of users that have been provided a particular digital component. To estimate the reach metric, the system can encode the non-unique user IDs of the users that have been provided with the particular digital component into a Bloom filter, and estimate the total number of unique users that have been provided with the particular digital component based on a total number of bits in the Bloom filter that have been set to one and a total number of possible values of the non-unique user ID.

In some implementations, the metrics include a frequency metric that characterizes a number of times a same user has been provided with a particular digital component.

Other implementations of this aspect include corresponding apparatus, systems, and computer programs, configured to perform the aspects of the methods, encoded on computer storage devices.

Particular embodiments of the subject matter described in this specification can be implemented so as to realize one or more of the following advantages.

The solutions described in this specification reduce privacy risks associated with storing, transmitting, and/or using potentially sensitive user data for computing metrics and/or selecting digital content to be provided to client devices. In particular, the specification provides techniques for generating and assigning a non-unique user identifier (ID) for each user in a user cohort. The non-unique user ID for a user can be in the form of a bit string that has a length that is less than a threshold length for a bit string to uniquely identify each user in the user cohort. In other words, multiple users will share the same non-unique user ID such that each non-unique ID does not uniquely identify any one user. Accordingly, the techniques provided by this specification avoid using unique user IDs to identify and allow tracking of individual users, and thus protecting user privacy. However, the use of non-unique user IDs can complicate the calculations of metrics that are used to measure the performance of digital content distribution campaigns and used to optimize the distribution of digital content to users.

This specification further provides techniques for accurately estimating metrics characterizing the user cohort based on non-identifying user data that includes the non-unique user IDs of the respective users in the cohort, and using the estimated metrics to adjust parameters for distributing digital components. Although the non-unique user IDs cannot be used to individually identify the users without additional information (and thus providing user privacy protection), these non-unique user IDs can provide information on the characteristics of the user cohort and can be processed to provide insights for guiding the selection of digital content to be provided to users. Accordingly, the system can use the privacy-preserving user data including the non-unique user IDs to guide the distribution of digital content to, for example, by adjusting distribution parameters based on metrics estimated from the privacy-preserving user data.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a digital component distribution system distributes digital components to client devices without identifying individual user identities.

FIG. 2 is a flow diagram of an example process for distributing digital components for presentation at client devices without identifying individual user identities.

FIG. 3 is a block diagram of an example computer system.

Like reference numbers and designations in the various drawings indicate like elements.

### DETAILED DESCRIPTION

In general, this specification describes systems and techniques for providing digital content, e.g., digital components, to client devices in ways that protect user privacy. A server can be configured to receive non-identifying user data from client devices and process the user data to update parameters characterizing distribution criteria for distributing the content.

Further to the descriptions throughout this document, a user may be provided with controls (e.g., user interface elements with which a user can interact) allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

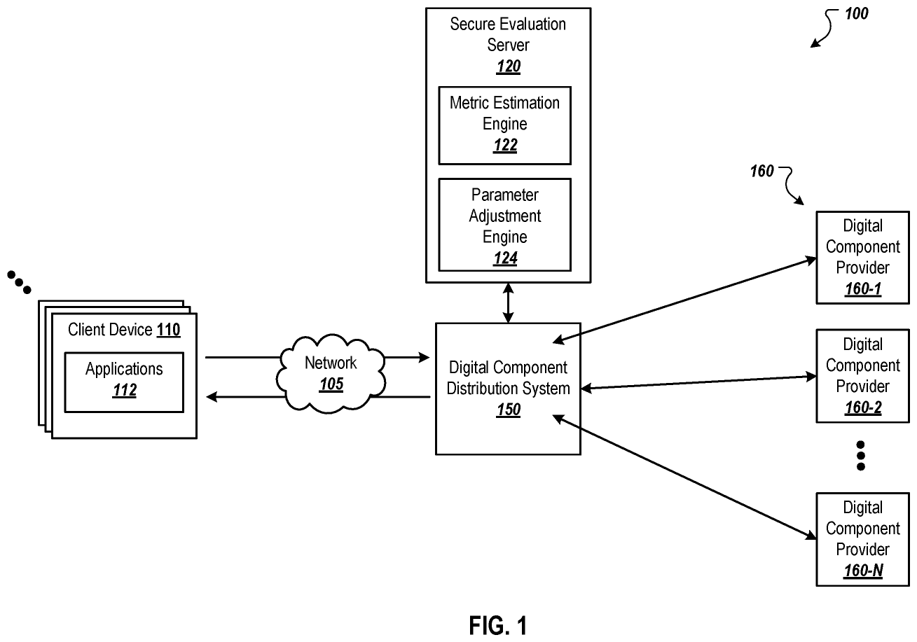

FIG. 1 is a block diagram of an example environment 100 in which a digital component distribution system 150 distributes digital components to client devices 110. The environment 100 includes a data communication network 105, such as a local area network (LAN), a wide area network (WAN), the Internet, a mobile network, or a combination thereof. The data communication network 105 connects client devices 110 to the digital component distribution system 150. The network 105 can also connect the digital component distribution system 150 to one another and/or to digital component providers 160-1, 160-2, and 160-3.

A client device 110 is an electronic device that is capable of communicating over the network 105. Example client devices 110 include personal computers, server computers, mobile communication devices, e.g., smart phones and/or tablet computers, and other devices that can send and receive data over the network 105. A client device can also include a digital assistant device that accepts audio input through a microphone and outputs audio output through speakers. The digital assistant can be placed into listen mode (e.g., ready to accept audio input) when the digital assistant detects a “hotword” or “hotphrase” that activates the microphone to accept audio input. The digital assistant device can also include a camera and/or display to capture images and visually present information. The digital assistant can be implemented in different forms of hardware devices including, a wearable device (e.g., a watch or a pair of glasses), a smart phone, a speaker device, a tablet device, or another hardware device. A client device can also include a digital media device, e.g., a streaming device that plugs into a television or other display to stream videos to the television, a gaming device, or a virtual reality system.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

A client device 110 can include applications 112, such as web browsers and/or native applications, to facilitate the sending and receiving of data over the network 105. A native application is an application developed for a particular platform or a particular device (e.g., mobile devices having a particular operating system). Although operations may be described as being performed by the client device 110, such operations may be performed by an application 112 running on the client device 110.

The applications 112 can present electronic resources, e.g., web pages, application pages, or other application content, to a user of the client device 110. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

An electronic resource is also referred to herein as a resource for brevity. In this specification, a resource can refer to a web page, application page, application content presented by a native application, electronic document, audio stream, video stream, or other appropriate type of electronic resource with which a digital component can be presented.

As used throughout this specification, the “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component. For example, the digital component may be content that is intended to supplement the content of a web page or other resource presented by the application 112. More specifically, the digital component may include digital content that is relevant to the resource content (e.g., the digital component may relate to the same topic as the web page content, or to a related topic). The provision of digital components can thus supplement, and generally enhance, the web page or application content.

When the application 112 loads a resource that includes a digital component slot, the application 112 can generate a digital component request that requests a digital component for presentation in the digital component slot. In some implementations, the digital component slot and/or the resource can include code (e.g., scripts) that cause the application 112 to request a digital component from the secure evaluation server 120.

A digital component request can also include contextual data, which is generally considered non-sensitive. The contextual data can describe the environment in which a selected digital component will be presented. The contextual data can include, for example, coarse location information indicating a general location of the client device 110 that sent the digital component request, a resource (e.g., website or native application) with which the selected digital component will be presented, a spoken language setting of the application 112 or client device 110, the number of digital component slots in which digital components will be presented with the resource, the types of digital component slots, and other appropriate contextual information.

A digital component request can also include a non-unique ID for the user. The non-unique user ID for the user can be assigned to the user by the application 112 or by the digital component distribution system 150. As described in more detail below, the non-unique user ID for a user can be a bit string that includes a sequence of multiple bits. When the application 112 sends a digital component request to the digital component distribution system 150, the application 112 can include the non-unique user ID so that the digital component distribution system 150 can use data for a user bucket (e.g., group of users having the same non-unique user ID) to select digital components for the user. Similarly, when the application 112 reports events, e.g., the presentation of a digital component, the application 112 can send the non-unique user ID for the user with the report so that a secure evaluation server 120 can estimate metrics for digital components.

The digital component distribution system 150 can identify a set of digital components that are eligible to be presented to the client device 110 from among a corpus of digital components that are available from the content platform 150. For example, the digital component distribution system 150 can select one or more digital components from digital components stored in a digital component repository and/or a set of digital components received from digital component providers 160.

The digital component repository can store digital components received from the digital component providers and additional data (e.g., metadata) for each digital component in a database. The metadata for a digital component can include, for example, distribution criteria that define the situations in which the digital component is eligible to be provided to a client device 110 in response to a digital component request received from the client device 110 and/or a selection parameter that indicates an amount that will be provided to the publisher if the digital component is displayed with a resource of the publisher and/or interacted with by a user when presented. The distribution criteria and the selection parameter can be characterized by one or more distribution parameters.

For example, the distribution parameters for a particular digital component can include distribution keywords that must be matched, e.g., by terms specified in the request) in order for the digital component to be eligible for presentation. In another example, the distribution criteria for a digital component can include location information indicating which geographic locations that digital component is eligible to be presented, user group membership data identifying user groups to which the digital component is eligible to be presented, resource data identifying resources with which the electronic resource is eligible to be presented, and/or other appropriate distribution criteria. The distribution criteria can also include negative criteria, e.g., criteria indicating situations in which the digital component is not eligible (e.g., with particular resources or in particular locations). The distribution parameters can also specify a selection parameter and/or budget for distributing the particular third-party content.

The digital component distribution system 150 can identify eligible digital components based on the distribution parameters and data included in the digital component request. The digital component distribution system 150 can then select a digital component from the eligible digital components and provide the selected digital component to the client device 110 for presentation to the user of the client device 110.

The secure evaluation server 120 receives and maintains privacy-preserving user data of a set of multiple users from a set of multiple client devices 110 or from the digital component distribution system 150. The secure evaluation server 120 can be implemented using one or more server computers (or other appropriate computing devices), that may be distributed across multiple locations. The secure evaluation server 120 can be operated and maintained by the digital component distribution system 150 or an independent trusted party, e.g., a party that is different from the users of the client devices, the parties that operate the digital component distribution system 150, and the digital component providers 160. For example, the secure evaluation server 120 can be operated by an industry group or a governmental group.

The privacy-preserving user data only includes non-personally identifiable information) of the users. That is, the user data does not include personally identifiable information that can be used by the secure evaluation server 120 or another party (e.g., a digital component distribution system) to uniquely identify a particular user.

In particular, in order to facilitate the digital component distribution system 150 to select eligible digital contents to be provided to a client device 110 while protecting user privacy, the user data for a user can include a non-unique user ID assigned to the user. Each non-unique user ID can be in the form of a bit string with a specific bit-string length (e.g., a specific number of bits in the string) assigned to the user. The bit-string length of each respective non-unique user ID is less than a threshold length that would allow a bit string to uniquely identify a user in the set of multiple users. For example, the bit-string length can be selected such that multiple users in the set are assigned to each bit string and thus each non-unique user ID is used to identify multiple users.

In general, to uniquely identify (or represent) each user in a set of multiple users without additional information, a bit string used as an user ID needs to contain a sufficient number of bits, e.g., contain at least a minimal number of bits, so that each particular user can be assigned a bit string that is unique to the particular user, that is, different from the bit strings assigned to any other users in the set of users. For example, to uniquely identify (or represent) each user in a set of n users, each bit string representing a user ID would include at least (log₂ n) bits.

The non-unique user ID includes fewer number of bits than what would allow (e.g., fewer than the minimal number of bits) for the unique identification of each particular user in the set of users. In some implementations, the client device 110, the secure evaluation server 120, or another computing device can determine the specific bit-string length of the respective bit string based at least on the size of the set users.

In some implementations, k-anonymity can be enforced to guarantee that, in a cohort of users, each user's data (before aggregation) is indistinguishable from at least k−1 other user's data. In particular, with non-unique IDs, most, if not all, users share a common non-unique ID with at least one other user in the cohort such that, for each non-unique ID, there is typically at least two users that have that non-unique ID. To enforce k-anonymity, the client device 110 or the secure evaluation server 120 can determine the bit-string length to guarantee, with a predefined confidence level, that a same bit string is assigned to at least a predefined number of users in the set of users.

In an illustrative example, the bit-string length can be determined, with a 95% probability, that each bit string is assigned to at least 50 users in the set of users. If each bit string has a length of 8 bits, and if there are 46 unique 8-bit strings, the expected number of distinct users is 50.7. As an estimate, this requires 48 unique 8-bit values to hit 95% confidence. The bit-string length of non-unique user ID can be adjusted based on the size of the user cohort. For example, to achieve the same confidence level for a same bit string being assigned to k users, a larger user cohort allows a greater number of bits for the non-unique ID compared to a smaller user cohort. Thus, a non-unique user ID can be generated so that its bit length, or its maximum value, depends on other information about a user. For example, there are more users in California than in Rhode Island, so a non-unique user ID can have more bits for a Californian than for a Rhode Islander.

In some implementations, the respective non-unique user ID for a user can be generated by selecting bits from a hash value computed by hashing a unique user ID that is used to uniquely identify the user. For example, the unique user ID can be a device ID that uniquely identifies the client device of the user (e.g., a string of numbers and/or letters uniquely generated for the client device upon initial setup) in a cohort of client devices, an ID that uniquely identifies a user account with a content publisher (e.g., a web site or application) in a cohort of users, an application ID that uniquely identifies the a unique instance of the application (and thus the user) of the client device, or another ID that uniquely identifies the user. Here, the cohort of client devices can be a global cohort of all the client devices of a particular type, or a particular group of client devices. The cohort of user accounts can be a global cohort of all user accounts registered with a particular party, or a particular group of user accounts. To generate the non-unique user ID, the client device 110 can compute a hashed bit string of the unique user ID using any appropriate hashing function, and select the specific number of bits from the hashed bit string (e.g., by truncating the hashed bit string).

In some implementations, the respective non-unique user ID can be generated by a random number generator. For example, the application 112 of the client device 110 can use a random number generator to generate a random bit string having the specific bit-string length, and includes the random bit string as the non-unique user ID in the privacy-preserving user data. The non-unique user ID that has been generated using a random number generator does not contain any user IDs or personal information, and thus is not vulnerable to ID or personal information-based dictionary attacks.

In some implementations, the non-unique user IDs (e.g., generated by truncating a hash value or by the random number generator) are uniformly distributed. The uniform distribution may be important to guarantee performance of certain downstream processing. The uniform distribution can be achieved by implementing a suitable hash function or a suitable random number generator.

For each non-unique user ID, the secure evaluation server 120 stores information about the users that are assigned that non-unique user ID. For example, the data for a non-unique user ID can include data identifying digital components presented to the users, data identifying whether a digital component is viewable on the user's screen and/or whether the digital component is muted, data identifying digital components selected by the users, data identifying the length of time a digital component (e.g., that includes an audio or a video clip) was played, data indicating completed conversion events that were completed after presentation and/or interaction with the digital component, data identifying the publisher resources that such digital components were presented with, data identifying the type of the application (e.g., browser) being used, and/or other appropriate data that can be used to compute metrics related to digital components.

A metric estimation engine 122 of the secure evaluation server 120 processes the privacy-preserving user data to estimate one or more metrics characterizing the set of users.

In some implementations, the estimated metrics include a reach metric that characterizes a total number of unique users in a particular user membership group. In one example, the reach metric can measure the total number of unique users in the set of users who have accessed a particular digital content or resource, or the total number of unique users to whom a particular digital component has been provided.

Conventionally, a computer system, e.g., a server, may rely on user IDs that are stable and uniquely identify users to support algorithms for computing metrics that facilitate selecting digital components for distribution to users. For example, a web browser of the client device can use a cookie to store a browser ID that uniquely identifies the web browser (and thus the user) of the client device. The server can receive user data including the browser ID, and process the user data to compute metrics such as reach, frequency, engagement, and/or engagement. However, third-party cookies may be deprecated by certain browsers. Further, due to increased concerns about protecting user privacy and security, it would be desirable to withhold information that can be used to uniquely identify the user from the server. However, it is challenging to determine metrics such as the unique reach metric based on anonymized user data. Since the same user or device can access a particular digital component multiple times, it is difficult to de-duplicate the multiple accesses by the same user or device without data tracking the unique identity of the user or device. This specification provides techniques to estimate metrics such as the reach metric based on the privacy-preserving user data including the non-unique user IDs for the set of users.

In one particular example, the secure evaluation server 120 can estimate the reach metric using a Bloom filter or another appropriate probabilistic data structure. The secure evaluation server 120 can encode the non-unique user IDs of the users that have been provided with a particular digital component into a Bloom filter, and estimate the total number of unique users that have been provided with the particular digital component based on a total number of bits in the Bloom filter that have been set to a value of on and a total number of possible values of the non-unique user ID. In particular, the secure evaluation server 120 can encode the values of a set of non-unique user IDs as indexes of a bit array for a Bloom filter. If a particular non-unique user ID is associated with a client device that has been provided with the particular digital component, the corresponding bit in the bit array is set to one, otherwise, the corresponding bit in the bit array is set to zero. The secure evaluation server 120 can estimate the number of unique users that have been provided with the digital content in the set using Equation (1):

$${n}^{*} = - m * ln [ 1 - \frac{X}{m} ] \qquad ( 1 )$$

wherein Equation 1, n* is an estimate of the number of unique users that have been provided with the digital component, m is the total number of non-unique user IDs, and X is the number of bits in the bit array that have been set to one.

In some implementations, the estimated metrics include a frequency metric that characterizes a number of times a same user has been provided with a particular digital component. As an illustrated example, consider a problem where users belong to two groups, A and B. Each group has its own frequency probability distribution (i.e. the probabilities that a user has accessed a particular digital component once, twice, three times etc) and these distributions have different L2 norms. The L1 norms for these groups, L_{1,A} and L_{1,B} are the average frequencies for these distributions. L_{2,A} and L_{2,B} are the L2 norms for these two distributions.

Let N_{A} and N_{B} be the number of users in these two groups. Let C be the total number of impressions, i.e. the sum of all per-bucket counts. C is necessarily the sum of user frequencies. The total number of hashes can be computed using Equation (2):

$$C = {N}_{A} {L}_{1 , A} + {N}_{B} {L}_{1 , B} \qquad ( 2 )$$

The secure evaluation server 120 can generate a normalized vector of counts for these self products. The Vector of Counts (VoC) self-product, V, is defined as the sum of the users' squared L2 norms (i.e. the sum of users' squared frequencies). V can be computed using Equation (3):

$$V = {N}_{A} {L}_{2 , {A}^{2}} + {N}_{B} {L}_{2 , {B}^{2}} \qquad ( 3 )$$

The secure evaluation server 120 can solve for N_{A} and N_{B} using Equations (2) and (3).

In some implementations, the secure evaluation server 120 can further estimate metrics such as the reach and frequency metrics for unions and/or intersections of multiple user sets. For example, the secure evaluation server 120 can use the VoC data structures to compute intersections and unions among two sets of users, when users on each set has been de-duplicated. A de-duplicated VoC of a user set is a vector of counts of unique users, where each user has been assigned to one element of the vector.

The secure evaluation server 120 can determine the elements of the VoC by counting, for each non-unique user ID (each user bucket value), how many unique users have that non-unique user ID. To estimate the size of the intersection of two user sets (which provides the de-duplicated reach metric of the intersection), the secure evaluation server 120 can determine the respective normalized VoC representing each user set, and compute a dot product (and a scaling factor just barely above 1) as the size of the intersection. In some implementations, the scaling factor can be computed as k/(k−1) with k being the bucket size. To estimate the size of the union (which provides the de-duplicated reach metric of the union), the secure evaluation server 120 can compute the sum of the sizes of the two user sets minus the intersection size as the size of the union.

When the VoCs are not from data that has already been de-duplicated, the expected value of the dot product of the two VoCs is more complicated than the size of the VoCs' intersection. The VoC computed from un-de-duplicated data includes a weight coefficient for each user's vector element. For example, if the VoC is computed from impression data, each user's weight coefficient is the user's frequency, i.e., how many impressions that user has been provided. When we take a dot product of two weighted VoCs, the expected value of the dot product is the sum, over users, of the product of each user's weights in the two vectors. When one VoC is weighted and another is not, the expected value of the dot product is the sum of weights of users in the intersection. Thus, the secure evaluation server 120 can estimate the total frequency of users who are present in two vectors using the above dot product.

In some implementations, the secure evaluation server 120 can estimate an attribution metric of the set of users from the privacy-preserving user data. The attribution metric quantifies user experiences where some users have been presented several different digital components leading to a specific action (e.g., a conversion), such as a user interaction with the provided digital component, a user sign-up, a purchase, etc. Attribution algorithms aim to attribute the conversion credit to the different digital components so that digital components that influenced users to convert are attributed more of the credit for those conversions. The secure evaluation server 120 can estimate the attribution metric by computing intersections with VoCs for a first set of users that have been provided the digital component and a second set of users that have performed the specific action. In order to improve the quality of the estimation, the secure evaluation server 120 can take into considerations of time, since the impression must occur before the conversion to be relevant for attribution. The secure evaluation server 120 can slice the VoCs of both the first and second set of users by time, and compute, for each ti, the intersection of users who had an impression before ti and converted between ti and ti+1.

In some implementations, the privacy-preserving user data can include per-publisher IDs (PPIDs), or an analogous ID. The PPID is assigned to the user by a particular publisher or digital content provider. The PPIDs cannot be used, by themselves, to directly compute de-duplicated cross-publisher metrics such as the cross-publisher reach metric. However, the secure evaluation server 120 can use the PPIDs to compute reach and frequency within each publisher, and use Equation (1) to de-duplicate the reach metric. In certain instances, the secure evaluation server 120 can compute intersections of the per-publisher reach metrics of multiple publishers. The secure evaluation server 120 can de-duplicate users within each publisher's scope. The secure evaluation server 120 can also break down per-publisher reach with frequency and combine these via intersections. That is, the secure evaluation server 120 can compute separate VoCs for each publisher and frequency.

In an illustrative example, RX,i is the number of unique users who have accessed i impressions from publisher X. The secure evaluation server 120 can compute Ti, the total number of unique users with exactly i impressions across publishers A and B, by combining VoCs for RA,j and RB,k where i=j+k.

A parameter adjustment engine 124 of the secure evaluation server 120 uses the estimated metrics to adjust one or more distribution parameters for distributing digital components to the set of users. The distribution parameters for a particular digital component characterize distribution criteria that define the situations in which the digital component is eligible to be provided to a client device 110 and/or a selection parameter that indicates an amount that will be provided to the publisher if the digital component is displayed with a resource of the publisher and/or interacted with by a user when presented.

For example, the distribution parameters for a particular digital component can include distribution keywords that must be matched, e.g., by terms specified in the request) in order for the digital component to be eligible for presentation. In another example, the distribution criteria for a digital component can include location information indicating which geographic locations that digital component is eligible to be presented, user group membership data identifying user groups to which the digital component is eligible to be presented, resource data identifying resources with which the electronic resource is eligible to be presented, and/or other appropriate distribution criteria. The distribution criteria can also include negative criteria, e.g., criteria indicating situations in which the digital component is not eligible (e.g., with particular resources or in particular locations). The distribution parameters can also specify a selection parameters and/or budget for distributing the particular third-party content.

The secure evaluation server 120 can adjust the distribution parameters based on metrics estimated by the metric estimation engine 122. For example, when the estimated reach metric or the estimated frequency metric of a particular digital component exceeds a predefined threshold for users from a particular geographic location, the secure evaluation server 120 can determine to remove the particular geographic location from the list of geographic locations for the particular digital component or a related digital component to be provided. In another example, when the estimated reach metric for the particular digital component exceeds a certain threshold and/or the estimated frequency metric for the particular digital exceeds a certain threshold for users in a particular user group, the secure evaluation server 120 can determine to add a related user group to the list of user groups for the particular digital component or a related digital component to be eligible for presentation. In another example, when the estimated reach metric for the particular digital component exceeds a certain threshold and/or the estimated frequency metric for the particular digital component exceeds a certain threshold, the secure evaluation server 120 can determine to increase or decrease the selection parameter and/or budget for distributing the particular digital component or a related digital component.

The secure evaluation server 120 can send the updated distribution parameters to the digital component distribution system 150, and the digital component distribution system 150 can select, according to the updated distribution parameters, digital components for distribution to client devices in response to receiving digital component requests from the client devices. The digital component distribution system 150 then can provide the digital components selected according to the updated distribution parameters to the client devices. The application 112 of the client device 110 can then present the digital component with the resource being presented by the application 112.

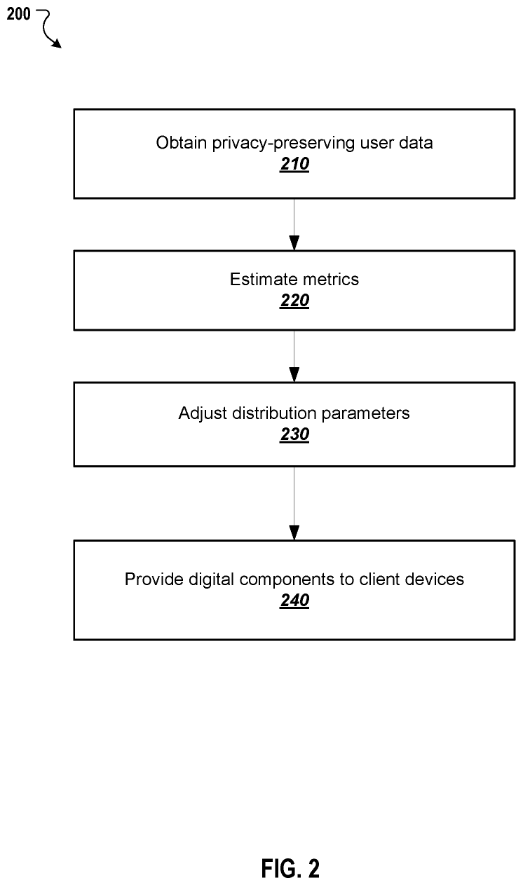

FIG. 2 is a flow diagram of an example process 200 for selecting and providing digital components for presentation on client devices in a privacy-preserving manner. Operations of the process 200 can be performed by a system of one or more computers located in one or more locations, such as a server, e.g., the digital component distribution system 150 and/or the secure evaluation server 120 described with reference to FIG. 1, appropriately programmed in accordance with this specification, can perform the process 200. Operations of the process 200 can also be implemented as instructions stored on one or more computer-readable media, which may be non-transitory, and execution of the instructions by one or more data processing apparatus can cause the one or more data processing apparatus to perform the operations of the process 200. For convenience and without loss of generality, the process 200 will be described as being performed by a data processing apparatus, e.g., a computer system.

At 210, the data processing apparatus obtains privacy-preserving user data for a set of users. The privacy-preserving user data from a respective user includes a non-unique user ID assigned to the user. Each non-unique user ID includes a respective bit string with a specific bit-string length (i.e., a specific number of bits in the string) assigned to the respective user. The bit-string length of each respective non-unique user ID is below a threshold length that allow a bit string to uniquely identify each user in the set of multiple of users. The privacy-preserving user data further includes data about digital components presented to users that have been assigned the non-unique user ID.

In some implementations, the respective non-unique user ID can be generated by a random number generator. In some other implementations, the respective non-unique user ID can be generated by selecting bits from a hash value computed by hashing a respective unique user ID identifying the respective user.

At 220, the data processing apparatus processes the privacy-preserving user data to estimate one or more metrics for one or more digital components. In some implementations, the estimated metrics include a reach metric that characterizes the total number of unique users in the set of users that have been provided a particular digital component.

In one particular example, the data processing apparatus can estimate the reach metric using a Bloom filter. The data processing apparatus can encode the non-unique user IDs of the users that have been presented with the particular digital component into the Bloom filter, and estimate the total number of unique users that have been provided with the particular digital component based on a total number of bits in the Bloom filter that have been set to one and a total number of possible values of the non-unique user ID.

In some implementations, the estimated metrics include a frequency metric that characterizes the number of times a same user has been provided with a particular digital component.

At 230, the data processing apparatus adjusts, based on the estimated metrics, one or more distribution parameters for distributing digital components to client devices in response to digital component requests. For example, the data processing apparatus can adjust, based on the estimated metrics, keywords that must be matched, a list of geographic locations that the digital component is eligible to be provided, a list of user groups to which the digital component is eligible to be provided, parameters characterizing resources with which the digital component is eligible to be presented, and/or other appropriate distribution parameters.

At 240, the data processing apparatus distributes the digital components to the client devices based on the distribution parameters.

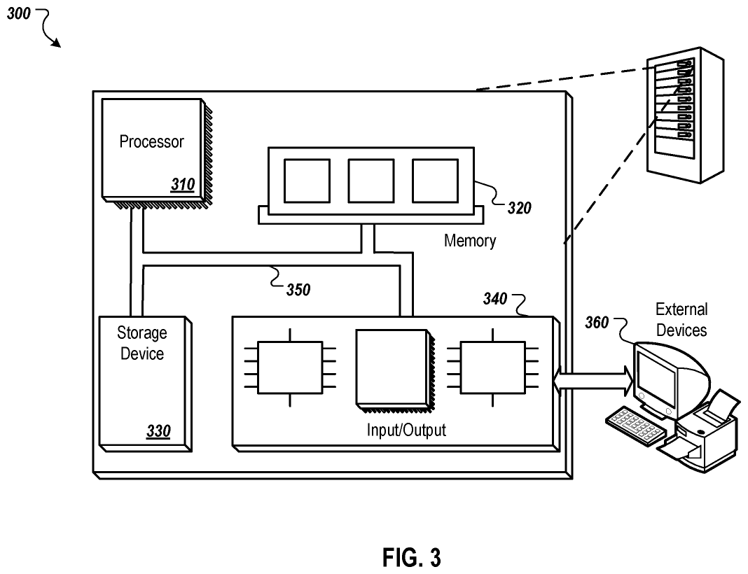

FIG. 3 is a block diagram of an example computer system 300 that can be used to perform the operations described above. The system 300 includes a processor 310, a memory 320, a storage device 330, and an input/output device 340. Each of the components 310, 320, 330, and 340 can be interconnected, for example, using a system bus 350. The processor 310 is capable of processing instructions for execution within the system 300. In some implementations, the processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In some implementations, the memory 320 is a volatile memory unit. In another implementation, the memory 320 is a non-volatile memory unit.

The storage device 330 is capable of providing mass storage for the system 300. In some implementations, the storage device 330 is a computer-readable medium. In various different implementations, the storage device 330 can include, for example, a hard disk device, an optical disk device, a storage device that is shared over a network by multiple computing devices (e.g., a cloud storage device), or some other large-capacity storage device.

The input/output device 340 provides input/output operations for the system 300. In some implementations, the input/output device 340 can include one or more of a network interface devices, e.g., an Ethernet card, a serial communication device, e.g., and RS-232 port, and/or a wireless interface device, e.g., an 802.11 card. In another implementation, the input/output device can include driver devices configured to receive input data and send output data to external devices 360, e.g., keyboard, printer, and display devices. Other implementations, however, can also be used, such as mobile computing devices, mobile communication devices, set-top box television client devices, etc.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
obtaining, by a data processing apparatus, privacy-preserving user data for a set of users, the privacy-preserving user data comprising, for each user in the set of users, a respective non-unique user ID comprising a bit string and data about digital components presented to users that have been assigned the non-unique user ID, wherein each bit string has a specific bit-string length that is less than a threshold length that allows a bit string to uniquely identify each user in the set of users;
processing, by the data processing apparatus, the privacy-preserving user data to estimate one or more metrics for one or more digital components;
adjusting, based on the estimated one or more metrics, one or more distribution parameters for distributing digital components to client devices in response to digital component requests; and
distributing digital components to the client devices based on the distribution parameters.

2. The method of claim 1, wherein the non-unique user ID for each user is generated by a random number generator of a client device of the user.

3. The method of claim 2, wherein the non-unique user ID is generated by selecting bits from a respective hash bit string computed by hashing a unique user ID that uniquely identifies the respective user.

4. The method of claim 1, further comprising determining the bit-string length of the respective bit string to guarantee, with a predefined confidence level, that a same bit string is assigned to at least a predefined number of users in the set of plurality of users.

5. The method of claim 1, wherein the one or more metrics comprise a reach metric that characterizes a total number of unique users in the set of users that have been provided a particular digital component.

6. The method of claim 5, wherein estimating the reach metric comprises:
encoding the non-unique user IDs of the users that have been provided with the particular digital component into a Bloom filter; and
estimating the total number of unique users that have been provided with the particular digital component based on a total number of bits in the Bloom filter that have been set to one and a total number of possible values of the non-unique user ID.

7. The method of claim 1, wherein the one or more metrics comprise a frequency metric that characterizes a number of times a same user has been provided with a particular digital component.

8. A system comprising:
one or more computers; and
one or more storage devices storing instructions that when executed by the one or more computers, cause the one or more computers to perform the operations comprising:
obtaining, by a data processing apparatus, privacy-preserving user data for a set of users, the privacy-preserving user data comprising, for each user in the set of users, a respective non-unique user ID comprising a bit string and data about digital components presented to users that have been assigned the non-unique user ID, wherein each bit string has a specific bit-string length that is less than a threshold length that allows a bit string to uniquely identify each user in the set of users;
processing, by the data processing apparatus, the privacy-preserving user data to estimate one or more metrics for one or more digital components;
adjusting, based on the estimated one or more metrics, one or more distribution parameters for distributing digital components to client devices in response to digital component requests; and
distributing digital components to the client devices based on the distribution parameters.

9. The system of claim 8, wherein the non-unique user ID for each user is generated by a random number generator of a client device of the user.

10. The system of claim 9, wherein the non-unique user ID is generated by selecting bits from a respective hash bit string computed by hashing a unique user ID that uniquely identifies the respective user.

11. The system of claim 8, wherein the operations further comprise determining the bit-string length of the respective bit string to guarantee, with a predefined confidence level, that a same bit string is assigned to at least a predefined number of users in the set of plurality of users.

12. The system of claim 8, wherein the one or more metrics comprise a reach metric that characterizes a total number of unique users in the set of users that have been provided a particular digital component.

13. The system of claim 12, wherein estimating the reach metric comprises:
encoding the non-unique user IDs of the users that have been provided with the particular digital component into a Bloom filter; and
estimating the total number of unique users that have been provided with the particular digital component based on a total number of bits in the Bloom filter that have been set to one and a total number of possible values of the non-unique user ID.

14. The system of claim 8, wherein the one or more metrics comprise a frequency metric that characterizes a number of times a same user has been provided with a particular digital component.

15. One or more computer-readable storage media storing instructions that, when executed by one or more computers, cause the one or more computers to perform the operations comprising:
obtaining, by a data processing apparatus, privacy-preserving user data for a set of users, the privacy-preserving user data comprising, for each user in the set of users, a respective non-unique user ID comprising a bit string and data about digital components presented to users that have been assigned the non-unique user ID, wherein each bit string has a specific bit-string length that is less than a threshold length that allows a bit string to uniquely identify each user in the set of users;
processing, by the data processing apparatus, the privacy-preserving user data to estimate one or more metrics for one or more digital components;
adjusting, based on the estimated one or more metrics, one or more distribution parameters for distributing digital components to client devices in response to digital component requests; and
distributing digital components to the client devices based on the distribution parameters.

16. The one or more computer-readable storage media of claim 15, wherein the non-unique user ID for each user is generated by a random number generator of a client device of the user.

17. The one or more computer-readable storage media of claim 16, wherein the non-unique user ID is generated by selecting bits from a respective hash bit string computed by hashing a unique user ID that uniquely identifies the respective user.

18. The one or more computer-readable storage media of claim 15, wherein the operations further comprise determining the bit-string length of the respective bit string to guarantee, with a predefined confidence level, that a same bit string is assigned to at least a predefined number of users in the set of plurality of users.

19. The one or more computer-readable storage media of claim 15, wherein the one or more metrics comprise a reach metric that characterizes a total number of unique users in the set of users that have been provided a particular digital component.

20. The one or more computer-readable storage media of claim 19, wherein estimating the reach metric comprises:
encoding the non-unique user IDs of the users that have been provided with the particular digital component into a Bloom filter; and
estimating the total number of unique users that have been provided with the particular digital component based on a total number of bits in the Bloom filter that have been set to one and a total number of possible values of the non-unique user ID.
